(19) United States
(12) Patent Application Publication
(10) Pub. No.: US 2008/0195544 A1
(43) Pub. Date: Aug. 14, 2008

(54) SYSTEM AND METHOD FOR GENERATING AN AUTHORIZATION ROLE ASSOCIATED WITH A SET OF ACCESS RIGHTS AND ASSIGNING THE AUTHORIZATION ROLE TO A CLASS OF ONE OR MORE COMPUTER USERS FOR ACCESSING SECURED RESOURCES

(75) Inventors: Velda Bartek, Apex, NC (US); Joseph A. Bohn, Durham, NC (US); Kathryn H. Britton, Chapel Hill, NC (US); Samar Choudhary, Morrisville, NC (US); Shikha Srivastava, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/673,207

(22) Filed: Feb. 9, 2007

(51) Int. Cl. G06Q 99/00

(52) U.S. Cl. 705/51

(57) ABSTRACT

A system and a method for generating an authorization role associated with a set of access rights and assigning the authorization role to a class of one or more computer users for accessing secured resources are provided.

### FIELD OF INVENTION

This application relates to a system and a method for generating an authorization role associated with a set of access rights and assigning the authorization role to a class of one or more computer users for accessing secured resources.

### BACKGROUND OF INVENTION

Computer administration interfaces have been utilized that display a large number of secured resources (also known as authorized tasks) contributed by various product groups or system integrators. The interface filters the authorized tasks based on assigned authorization roles to users, such that a specific user only has access to view the authorized tasks associated with the authorization role or combination of authorization roles they have been assigned. However, creating and maintaining appropriate user roles for assigning user access rights is a relatively difficult and time-consuming process and is not closely related to the resultant view that a user will have of the system. In particular, authorization roles associated with tasks are generally maintained by editing deployment files to create, update, or delete role definitions, without a clear understanding of the view that will be seen by a class of computer users that are given permission to the authorization role.

Accordingly, the inventors herein have recognized a need for an improved system and a method for generating and assigning access rights in the form of authorization roles to a class of one or more users for accessing secured resources in a manner which provides a visual context that mirrors one potential view for the class of computer users that will be granted access to the authorization role.

### SUMMARY OF INVENTION

A method for generating an authorization role associated with a set of access rights and assigning the authorization role to a class of one or more computer users for accessing secured resources in accordance with an exemplary embodiment is provided. The method includes displaying a first graphical user interface with a plurality of user selection controls associated with a plurality of secured resources presented in a manner that is consistent with a potential view by the class of one or more computer users. The method further includes selecting at least a first user selection control from the plurality of user selection controls utilizing the first graphical user interface. The first user selection control is associated with a first secured resource from the plurality of secured resources. The method further includes assigning an authorization role name to the selected first secured resource, utilizing the first graphical user interface. The method further includes assigning at least one user group name associated with the class of one or more computer users to the authorized role name, utilizing the first graphical user interface, such that the class of one or more computers users are authorized to access the first secured resource.

A system for generating an authorization role associated with a set of access rights and assigning the authorization role to a class of one or more computer users for accessing secured resources in accordance with another exemplary embodiment is provided. The system includes a computer server configured to store data in a disk subsystem associated with a plurality of secured resources. The system further includes a client computer operably communicating with the computer server and a display device. The client computer is configured to display a first graphical user interface with a plurality of user selection controls associated with a plurality of secured resources presented in a manner that is consistent with a potential view by the class of one or more computer users. The client computer is further configured to allow a system administrator to select at least a first user selection control from the plurality of user selection controls utilizing the first graphical user interface. The first user selection control is associated with a first secured resource from the plurality of secured resources. The client computer is further configured to allow the system administrator to assign an authorization role name to the selected first secured resource, utilizing the first graphical user interface. The client computer is further configured to allow the system administrator to assign at least one user group name associated with the class of one or more computer users to the authorized role name, utilizing the first graphical user interface, such that the class of one or more computers users are authorized to access the first secured resource.

### BRIEF DESCRIPTION OF DRAWINGS

FIG. 1 is a block diagram of a system for generating an authorization role associated with a set of access rights and assigning the authorization role to a class of one or more computer users for accessing secured resources in accordance with an exemplary embodiment.

FIG. 2 is a schematic of a graphical user interface (GUI) utilized by the system of FIG. 1;

FIG. 3 is a schematic of another GUI having a plurality of user selection controls utilized by the system of FIG. 1;

FIG. 4 is a schematic of another GUI utilized by the system of FIG. 1;

FIG. 5 is a schematic of another GUI utilized by the system of FIG. 1; and

FIGS. 6 and 7 are flowcharts of a method for generating an authorization role associated with a set of access rights and assigning the authorization role to a class of one or more computer users for accessing secured resources in accordance with another exemplary embodiment.

### DESCRIPTION OF AN EMBODIMENT

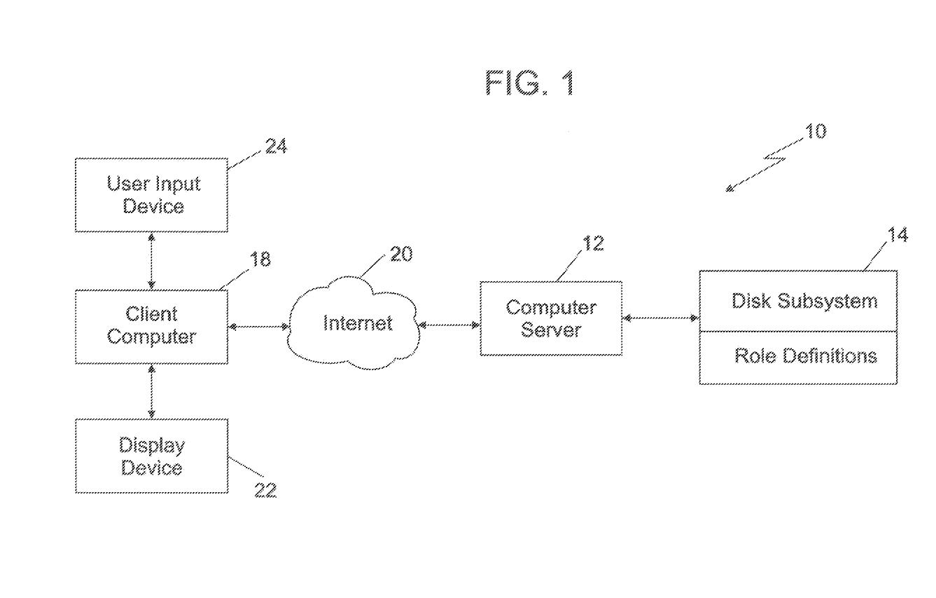

Referring to FIG. 1, a system 10 for generating an authorization role associated with a set of access rights and assigning the authorization role to a class of one or more computer users for accessing secured resources is illustrated. A secured resource is a software algorithm, a hardware device, or an operational task performed in a computer system, whose access is restricted to authorized computer users. A user selection control is a user interface entity that is selectable by a class of computer users. The system 10 includes a computer server 12, a disk subsystem 14, a client computer 18, the Internet 20, a display device 22, and a user input device 24.

The computer server 12 is provided to retrieve data associated with a plurality of secured resources that is stored in the disk subsystem 14. The computer server 12 communicates with the disk subsystem 14 and the Internet 20.

The disk subsystem 14 is provided to store data associated with the plurality of secured resources and role definitions. The role definitions include authorization role names associated with secured resources. The role definitions are utilized to assign access rights to a class of one or more computer users.

The user input device 24 is provided to allow a user to input data into the client computer 18. In one exemplary embodiment, the user input device 24 comprises a keyboard. Of course, in alternative embodiments, other devices known to those skilled in the art for inputting data could be utilized.

The client computer 18 is provided to communicate with the computer server 12 via the Internet 20. In particular, the client computer 18 requests data associated with the plurality of secured resources that is stored in the disk subsystem 14. Further, the client computer 18 is provided to instruct the display device 22 to display the graphical user interfaces 40, 60, 130, and 150 based on the data received from the computer server 12.

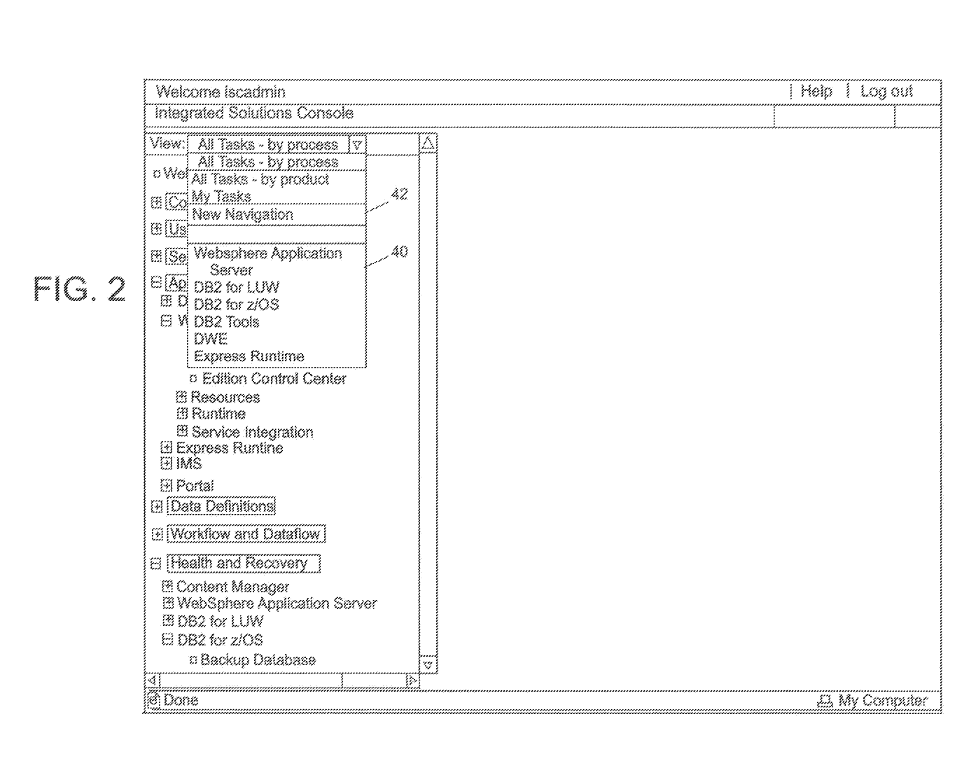

Referring to FIG. 2, the GUI 40 is provided to allow user to develop a customized role definition. In particular, when a user selects a user selection control 42 on the GUI 40, the client computer 18 instructs the display device 22 to display the GUI 60. It should be noted that in an exemplary embodiment, the user selection control 42 is a drop-down list. However, in alternative embodiments, the user selection control 42 could be replaced with other types of user selection controls known to those skilled in the art.

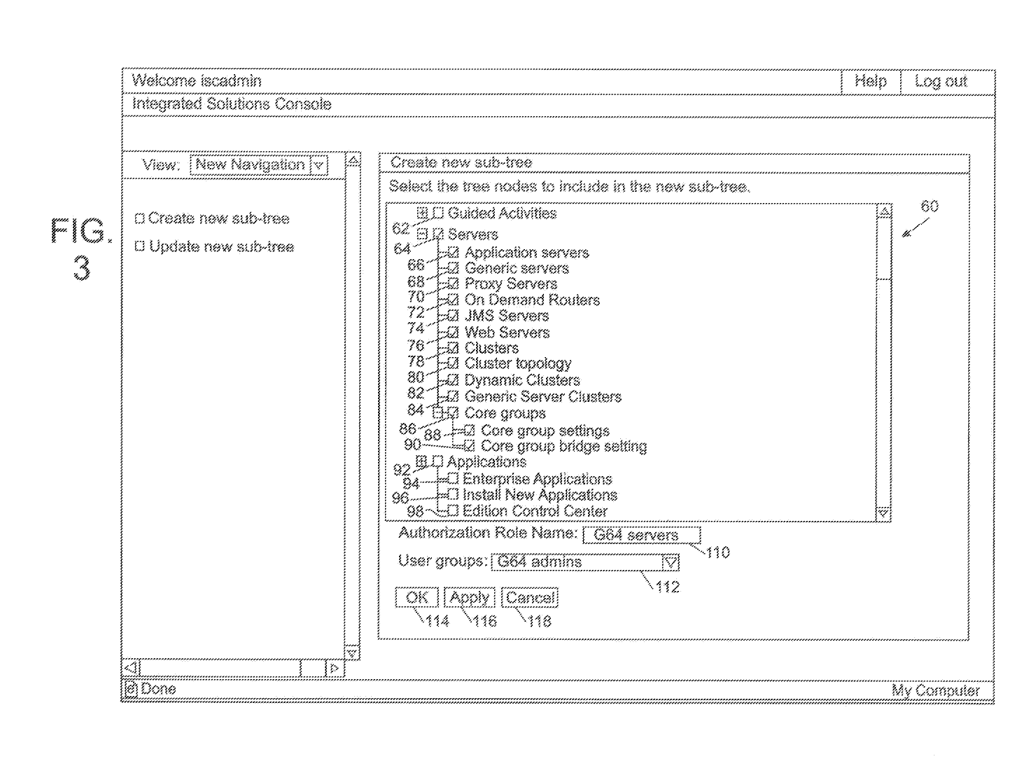

Referring to FIG. 3, the GUI 60 is provided to allow the user to select user selection controls associated with a plurality of secured resources. In particular, the GUI 60 includes the user selection controls 62, 64, 66, 68, 70, 72, 74, 76, 78, 80, 82, 84, 86, 88, 90, 92, 94, 96, 98 for allowing a computer used to select secured resources associated with the selection controls. For example, the user selection control 66 is associated with the “Application servers” secured resource. It should be noted that a complete set of secured resources that can be selected by a system administrator are presently visually in a manner that a class of computer users would view these secured resources if assigned an appropriate authorization role that includes access rights to these secured resources. In other words, the system administrator has a “what you see is what you get” (WYSIWYG) view of the selected resources from the plurality of secured resources. It should be noted that in an exemplary embodiment, the user selections controls 62-98 are checkboxes. However, in alternative embodiments, the user selection controls 62-98 can be replaced by other user selection controls known to those skilled in the art. The GUI 60 further includes an authorization role name input control 110 and a user group input control 112. The computer user can utilize the authorization role name input control 110 to input an authorization role name associated with selected secured resources. For example, the computer user can utilize the control 110 to input the authorization role name “G64 services” associated with the selected resources specified by user selection controls 64-90. The computer user can utilize the user group input control 112 to input a name of a user group associated with the class of one or more computers users in order to associate the user group with the authorization role name. For example, the computer user can utilize the control 112 to input the “G64 admins” user group to associate the user group to the authorization role name “G64 servers.” It should be noted that in an alternative embodiment, the authorization role name input control 110 can be replaced with a drop-down menu of pre-existing authorization role names. Further, the user group control 112 can be replaced with a drop-down menu of pre-existing authorization user group names. Finally, the GUI 60 includes user controls 114, 116 and 118. The computer user can utilize the user control 116 to accept the user selections and the user control 114 to store the user selections in a memory. A computer user can utilize the user control 118 to cancel any user selections on the GUI 60.

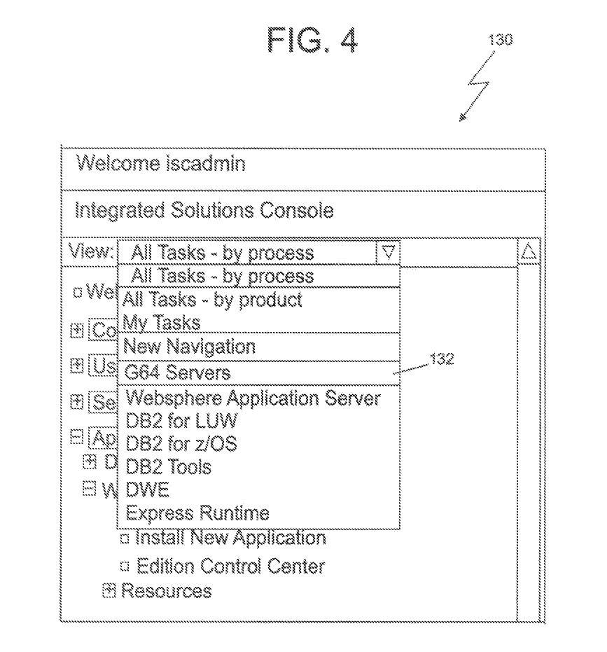

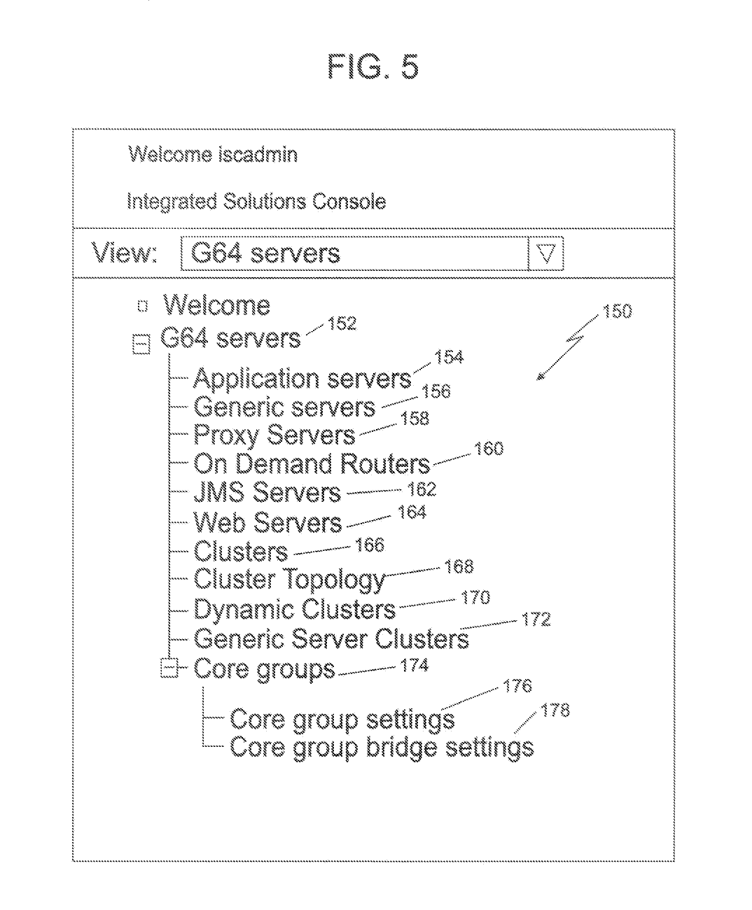

Referring to FIGS. 4 and 5, the GUI 130 is provided to allow the user to select a user interface selection control associated with an authorization role name. In particular, the GUI 130 includes the user interface selection control 132 associated with the authorization role name specified by the computer user utilizing the GUI 60. When a computer user selects a control 132, the client computer 18 instructs the display device 22 to display the GUI 150. The GUI 150 includes the secured resource selection controls 152, 155, 156, 158, 160, 162, 164, 168, 170, 172, 174, 176, and 178 associated with associated secured resources. For example, the secured resource selection control 154 is associated with an “Application servers” secured resource.

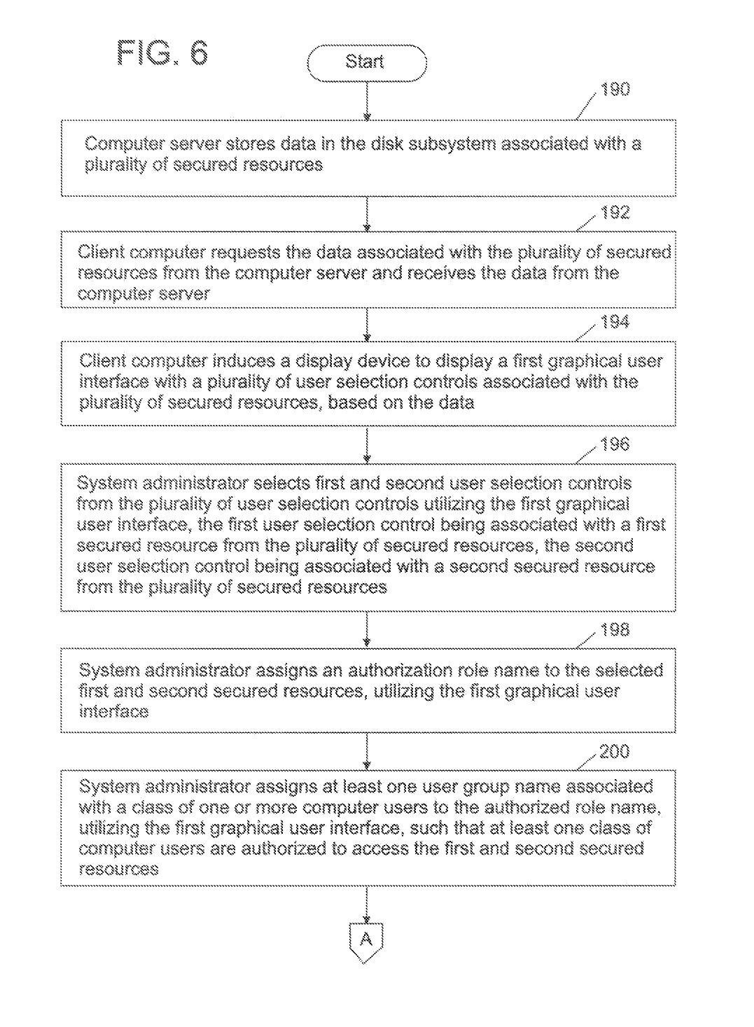

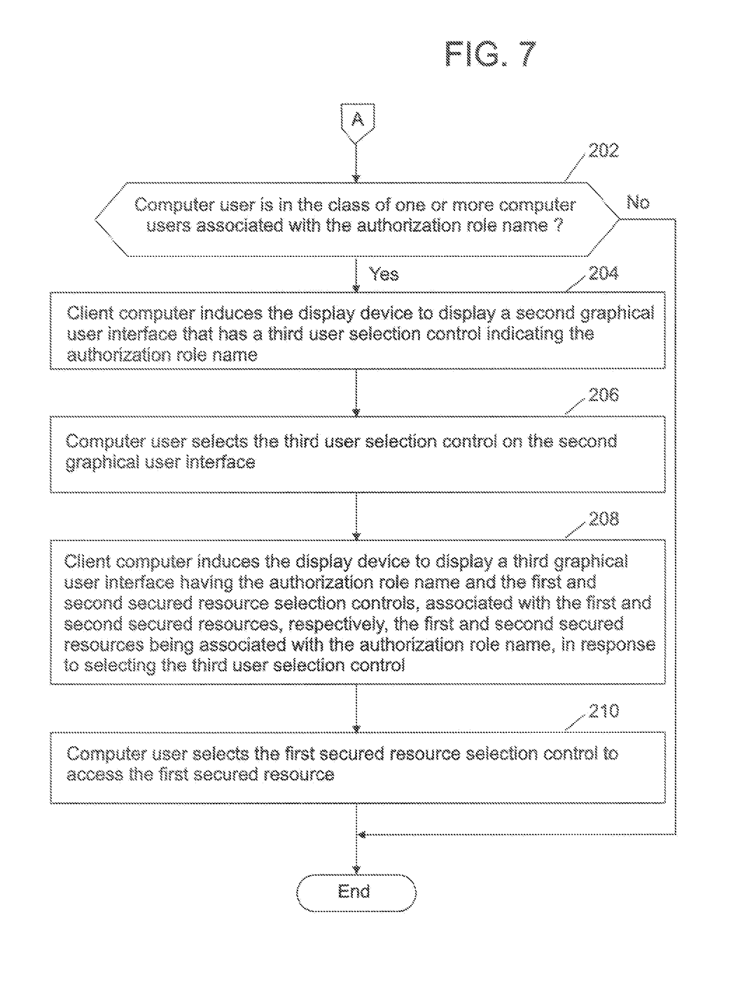

Referring to FIGS. 6-7, a method for assigning access rights to a class of one or more computer users for accessing secured resources will now be explained. The method can be implemented utilizing the system 10 described above.

At step 190, the computer 12 stores data in the disk subsystem 14 associated with a plurality of secured resources.

At step 192, the client computer 18 requests the data associated with the plurality of secured resources from the computer server 12 and receives the data from the computer server 12.

At step 194, the client computer 18 induces the display device 22 to display the GUI 60 with a plurality of user selection controls associated with the plurality of secured resources, based on the data. As discussed above, the GUI 40 is utilized to instruct the client computer 18 to induce the display device 22 to display the GUI 60. The GUI 60 presents a complete set of secured resources in a manner that mirrors a visual presentation to a class of users if they were authorized to all of the secured resources so that a system administrator can visually comprehend relationships between the secured resources.

At step 196, a system administrator selects first and second user selection controls from the plurality of user selection controls utilizing the GUI 60. The GUI 60 presents user selection controls as checkboxes. However, in alternative embodiments, the user selection controls can be various other types of selection controls known to those skilled in the art including filter algorithms, searching algorithms, and multi-selection controls for example. In the exemplary embodiment, the first user selection control is associated with a first secured resource from the plurality of secured resources. The second user selection control is associated with a second secured resource from the plurality of secured resources. For example, the system administrator can select the user selection controls 66, 68 associated with an “Application servers” and “Generic Servers” secured resources, respectively. Of course, the system administrator can select additional user selection controls if desired. It should be noted that although in the exemplary step 196, first and second user selection controls are selected, in an alternative step 196, only one of the first and second user selection controls could be selected.

At step 198, the system administrator assigns an authorization role name to the selected first and second secured resources, utilizing the GUI 60. For example, the system administrator can assign an authorization role name “G64 servers” to the selected “Application servers” and “Generic Servers” secured resources.

At step 200, the system administrator assigns at least one user group name associated with a class of one or more computer users to the authorized role name, utilizing the GUI 60, such that at least one class of computer users are authorized to access the first and second secured resources. For example, the system administrator can assign the user group name “G64 admins” associated with a class of one or more computer users to the authorized role name “G64 servers.”

At step 202, the client computer 18 makes a determination as to whether the computer user is in the class of one or more computer users associated with the authorization role name. If the value of step 202 equals “yes”, the method advances to step 204. Otherwise, the method is exited.

At step 204, the client computer 18 induces the display device 22 to display GUI 130 that has a third user selection control indicating the authorization role name. For example, the client computer 18 can induce the display device 22 to display the GUI 130 having the user selection control 132 indicating the authorization role name “G64 servers.”

At step 106, the computer user selects the third user selection control on the GUI 130. For example, the computer user can select the user selection control 132 on the GUI 130.

At step 208, the client computer 18 induces the display device 22 to display a GUI 150 having the authorization role name and the first and second secured resource selection controls, associated with the first and second secured resources, respectively, the first and second secured resources being further associated with the authorization role name, in response to selecting the third user selection control. For example, the client computer 18 can induce the display device 22 to display the GUI 150 having the authorization role name “G64 servers” and at least secured resource selection controls 154, 156 associated with “Application servers” and “Generic servers” secured resources, respectively, the “Application servers” and “Generic servers” secured resources being further associated with the authorization role name “G64 servers” in response to selecting the user selection control 132.

At step 210, the computer user selects the first secured resource selection control to access the first secured resource. For example, the computer user can select the secured resource selection control 154 to access the “Application servers” secured resource. After step 210, control is passed to the selected secured resource (a user task in the exemplary embodiment) and the method is exited.

The system and the method for generating an authorization role associated with a set of access rights and assigning the authorization role to a class of one or more computer users for accessing secured resources provide a substantial advantage over other methods. In particular, the system provides a technical effect of allowing a system administrator to visually see the results of selecting various secured resources from a plurality of secured resources, as a class of users associated with the resultant authorization role will view the secured resources, and to further assign authorization role names to the secured resources and a user group name associated with a class of one or more computer users to the authorization role name.

While the invention is described with reference to an exemplary embodiment, it will be understood by those skilled in the art that various changes may be made and equivalent elements may be substituted for elements thereof without departing from the scope of the invention. In addition, many modifications may be made to the teachings of the invention to adapt to a particular situation without departing from the scope thereof. Therefore, it is intended that the invention not be limited the embodiment disclosed for carrying out this invention, but that the invention includes all embodiments falling with the scope of the appended claims. Moreover, the use of the term's first, second, etc. does not denote any order of importance, but rather the term's first, second, etc. are used to distinguish one element from another.

We claim:

1. A method for generating an authorization role associated with a set of access rights and assigning the authorization role to a class of one or more computer users for accessing secured resources, comprising:
displaying a first graphical user interface with a plurality of user selection controls associated with a plurality of secured resources presented in a manner that is consistent with a potential view by the class of one or more computer users;
selecting at least a first user selection control from the plurality of user selection controls utilizing the first graphical user interface, the first user selection control being associated with a first secured resource from the plurality of secured resources;
assigning an authorization role name to the selected first secured resource, utilizing the first graphical user interface; and
assigning at least one user group name associated with the class of one or more computer users to the authorized role name, utilizing the first graphical user interface, such that the class of one or more computers users are authorized to access the first secured resource.

2. The method of claim 1, wherein the first graphical user interface provides a WYSIWYG view of the plurality of secured resources for a system administrator.

3. The method of claim 1, further comprising:
displaying a second graphical user interface that has a third user selection control indicating the authorization role name;
selecting the third user selection control on the second graphical user interface; and
displaying a third graphical user interface in response to selecting the third user selection control, the third user selection control having the authorization role name and at least a first secured resource selection control, associated with the first secured resource, that is further associated with the authorization role name, to verify that the authorization role name is associated with a desired view for the class of one or more computer users.

4. The method of claim 3, further comprising selecting the first secured resource selection control to access the first secured resource.

5. A system for generating an authorization role associated with a set of access rights and assigning the authorization role to a class of one or more computer users for accessing secured resources, comprising:
a computer server configured to store data in a disk subsystem associated with a plurality of secured resources; and
a client computer operably communicating with the computer server and a display device, the client computer configured to display a first graphical user interface with a plurality of user selection controls associated with a plurality of secured resources presented in a manner that is consistent with a potential view by the class of one or more computer users;
the client computer further configured to allow a system administrator to select at least a first user selection control from the plurality of user selection controls utilizing the first graphical user interface, the first user selection control being associated with a first secured resource from the plurality of secured resources;
the client computer further configured to allow the system administrator to assign an authorization role name to the selected first secured resource, utilizing the first graphical user interface; and
the client computer further configured to allow the system administrator to assign at least one user group name associated with the class of one or more computer users to the authorized role name, utilizing the first graphical user interface, such that the class of one or more computers users are authorized to access the first secured resource.

6. The system of claim 5, wherein the first graphical user interface provides a WYSIWYG view of the plurality of secured resources for the system administrator.

7. The system of claim 5, wherein the client computer is further configured to display a second graphical user interface that has a third user selection control indicating the authorization role name on the display device, the client computer further configured to allow the system administrator to select the third user selection control on the second graphical user interface, the client computer further configured to display a third graphical user interface on the display device in response to selecting the third user selection control, the third graphical user interface having the authorization role name and at least a first secured resource selection control, associated with the first secured resource and associated with the authorization role name, to verify that the authorization role name is associated with a desired view for the class of one or more computer users.

8. The system of claim 5, wherein the client computer is further configured to allow a user to select the first secured resource selection control to access the first secured resource.
